(19) United States
(12) Patent Application Publication
(10) Pub. No.: US 2016/0307374 A1
(43) Pub. Date: Oct. 20, 2016

(54) METHOD AND SYSTEM FOR PROVIDING INFORMATION ASSOCIATED WITH A VIEW OF A REAL ENVIRONMENT SUPERIMPOSED WITH A VIRTUAL OBJECT

(71) Applicant: METAIO GMBH, Munich (DE)

(72) Inventors: Daniel Kurz, Cupertino, CA (US); Lejing Wang, Cupertino, CA (US)

(21) Appl. No.: 15/100,355

(22) PCT Filed: Dec. 19, 2013
(86) PCT No.: PCT/EP2013/077493

§ 371 Date: May 31, 2016

(51) Int. Cl. G06T 19/20; G06F 3/01; G06T 15/06; G06T 19/00

(52) U.S. Cl. CPC G06T 19/20; G06T 19/006; G06F 3/012; G06F 3/013; G06T 15/06; G06T 2219/2016

(57) ABSTRACT

Providing information associated with a view of a real environment superimposed with a virtual object, includes obtaining a model of a real object located in a real environment and a model of a virtual object, determining a spatial relationship between the real object and the virtual object, determining a pose of a device displaying the view relative to the real object, determining a visibility of the virtual object in the view according to the pose of the device, the spatial relationship and the models of the real object and the virtual object, and if the virtual object is not visible in the view, determining a movement for at least one of the device and at least part of the real object such that the virtual object is visible in the view in response to the at least one movement, and providing information indicative of the at least one movement.

### BACKGROUND

The present disclosure is related to a method and system for providing information associated with a view of a real environment which is superimposed with a virtual object.

Augmented Reality (AR) systems and applications are known to enhance a view of a real environment by providing a visualization of overlaying computer-generated virtual information with a view of the real environment. The virtual information can be any type of visually perceivable data such as objects, texts, drawings, videos, or their combination. The view of the real environment could be perceived as visual impressions by user's eyes and/or be acquired as one or more images captured by a camera, e.g. held by a user or attached on a device held by a user. For this purpose AR systems integrate spatially registered virtual objects into the view. The real object enhanced with the registered virtual objects can be visually observed by a user. The virtual objects are computer-generated objects.

The viewer which provides the view of the real environment to be superimposed with the virtual object may be a camera that could capture a real object in an image. In this case, the overlay of the virtual object and the real object can be seen by the user in a so-called video see-through AR setup, which is known in the art, having the camera and a normal display device. The viewer may also be an eye of the user. In this case, the overlaid virtual object and the real object can be seen by the user in a so-called optical see-through AR setup, which is known in the art, having a semi-transparent display (such as a head worn glasses, screen or helmet). The user then sees through the semi-transparent display the real object augmented with the virtual object blended in the display.

The viewer may also be a projector that could project visual information within its projecting area. The field of the view of the projector may depend on the field of its projecting area. In this case, a projector projects a virtual object onto the surface of a real object or a part of a real object. This is also known as so-called projective AR.

To allow for spatially proper registration or overlay of a real object and a virtual object, a spatial relationship (in particular a rigid transformation) between the virtual object and the real object should be provided. Further, a pose of the viewer relative to the real object is required for a proper registration. Depending on the pose of the viewer relative to the real object, the virtual object can be located (partially) in front of the real object or (partially) behind the real object, or both at the same time. To ensure a seamless integration of virtual and real objects, such occlusions are preferred to be handled by simply not displaying those parts of the virtual object that are located behind a real object. In this way, the occluded parts of the virtual object become invisible to achieve a more natural viewing experience. A common terminology in this case is that the virtual object is (partially) occluded by the real object.

The virtual object can also be fully located relative to the real object within the field of view of the viewer or it can be partially (or fully) outside of the field of view depending on the pose of the viewer and the spatial relationship between the virtual object and the real object. In a projective AR setup, each point of a virtual object can either be projected onto a physical surface (i.e. projection surface) from the pose of the viewer (i.e. projector) or it is not projected onto any physical surface and can therefore not be observed, making it invisible. Further, a preferred projection surface may be occluded by another real object with respect to the projector, i.e. the another real object is located between the preferred projection surface and the projector.

Thus, for a given setup of an Augmented Reality system and arrangement of the real object, the virtual object, and the viewer, an improper pose of the viewer relative to the real object may result in that the virtual object is fully occluded by the real object or the virtual object is fully outside of the field of the view of the viewer. Consequently, the virtual object may not be visible to the user. This can give confusing impressions to the user. The user may believe that the Augmented Reality system is not working, or that the real object in sight does not have any virtual object related to it. In any case, this may result in a non-satisfying user experience.

Augmented Reality navigation or touring applications are known, which guide a user to a place in a real world with visual instructions overlaid onto an image of the real world. For example, an arrow overlaid onto the image of a real world shows the direction to the next door, portal, or point-of-interest, indicating either to move forward, or to turn left or right.

There are applications in which a user first defines a targeted real place or real object and then uses a video see-through AR system to guide him or her to the target. If the camera does not point in a direction such that at least one target is inside the field of the view of frustum, the application may show an indicator, such as an arrow, overlaid on top of the camera image shown on the display of the video see-through system. The arrow could show to the user in which direction to turn the camera in order to see the targeted (real) object on the display.

However, previous AR navigation systems do not identify whether any virtual information is visible to the user and, thus, a non-satisfying user experience, as described above, can occur in these applications as well.

Bichlmeier et al. propose an intuitive method to obtain a desired view onto a virtual object which is different from the current viewpoint of the virtual camera without the need to move the display, the eye or a physical camera. A tangible/controllable virtual mirror simulates the functionality of a real mirror and reflects the virtual object which in this case is 3D medical imaging data that has a pre-defined spatial relationship with a patient (i.e. a real object). The authors mention to move a real object or a viewpoint to have a desired view on virtual information registered to the real object. However, they do not address the problem of the virtual object being invisible caused by the virtual object being entirely occluded by the real object or the virtual object being entirely outside of the field of the view of the viewer.

Breen et al. disclose an occlusion method for correctly occluding a virtual object by a real object or a part of a real object in an AR view which overlays an image of the real object with a view of a virtual object. They propose to detect if the virtual object is placed behind the real object from a viewpoint of the viewer (i.e. a camera in this case) by using a model of the real object or a depth map of the real object from the according viewpoint.

None of these address the problem that a virtual object associated to a real object being invisible to the user in AR visualization may be caused by the virtual object being entirely occluded by the real object or the virtual object being entirely outside of the field of view of the viewer (a camera, an eye, or a projector depending on the AR setup), that may be a result from an improper pose of the viewer relative to the real object. As described above, this may result in a non-satisfying user experience.

Therefore, it would be desirable to have a method associated with providing a view of a real environment superimposed with a virtual object that contributes to a satisfying user experience in situations as outlined above.

### SUMMARY

According to an aspect, there is disclosed a method of providing information associated with a view of a real environment superimposed with a virtual object, the method comprising the steps of providing a model of a real object located in the real environment and providing a model of the virtual object, providing a spatial relationship between the real object and the virtual object, providing a visibility condition, providing a pose of a viewer which is adapted to provide the view of the real environment to be superimposed with the virtual object, wherein the provided pose is relative to the real object, determining a visibility of the virtual object in the view provided by the viewer according to the pose of the viewer, the spatial relationship between the real object and the virtual object, and the models of the real object and the virtual object, determining if the visibility of the virtual object fulfils the visibility condition, and if the visibility of the virtual object does not fulfil the visibility condition, determining at least one movement for moving at least one of the viewer and at least part of the real object such that the visibility of the virtual object will fulfil the visibility condition after performance of the at least one movement, and providing information indicative of the at least one movement for presentation to a user.

According to another aspect, there is disclosed a system for providing information associated with a view of a real environment superimposed with a virtual object, comprising a processing system which is configured to receive or determine a model of a real object located in the real environment and providing a model of the virtual object, a spatial relationship between the real object and the virtual object, a visibility condition, and a pose of a viewer which is adapted to provide the view of the real environment to be superimposed with the virtual object, wherein the provided pose is relative to the real object. The processing system is further configured to determine a visibility of the virtual object in the view provided by the viewer according to the pose of the viewer, the spatial relationship between the real object and the virtual object, and the models of the real object and the virtual object, to determine if the visibility of the virtual object fulfils the visibility condition, and if the visibility of the virtual object does not fulfil the visibility condition, determining at least one movement for moving at least one of the viewer and at least part of the real object such that the visibility of the virtual object will fulfil the visibility condition after performance of the at least one movement, and to provide information indicative of the at least one movement for presentation to a user.

According to an embodiment, the viewer is or comprises a camera, an eye, a display screen, a head mounted display, or a projector. For example, the viewer is included in a handheld device or a wearable device, such as a mobile phone, a tablet computer, or a head mounted device.

The present invention discloses to identify, e.g., improper poses of the viewer and, in case they occur, to provide the user with information, such as instructions, how to reach a pose of the viewer which results in at least part of the virtual object being visible to the user in the view provided by the viewer. Depending on the particular setup, this information or instructions can include indications how to move the camera, the eye, the display screen, the head mounted display, the projector or at least part of the real object.

The proposed method can identify whether a virtual object in AR visualization is (partially) invisible caused by an improper pose of the viewer relative to a real object, and may also provide information how to reach a pose of the viewer which results in at least part of the virtual object being visible to the user in the provided view. Thus, the invention contributes to solving the problem of virtual information related to a real object not being visible to a user in an Augmented Reality system due to an unfavourable viewpoint of a camera or of a projector or of the user.

For example, the processing system is comprised in the viewer, in a mobile device (such as a mobile phone or tablet computer) adapted to communicate with the viewer (e.g. a head mounted display), and/or in a server computer adapted to communicate with the viewer. The processing system may be comprised in only one of these devices, or may be a distributed system in which one or more processing tasks are distributed and processed by one or more components which are communicating with each other, e.g. by point to point communication or via a network.

According to an embodiment, the visibility condition is a target criterion or an indicator for the visibility of the virtual object.

According to a further embodiment, the visibility of the virtual object is defined according to a fraction of the virtual object which is visible or invisible in the view.

According to an embodiment, the visibility of the virtual object is defined according to a visibility of at least one part of the virtual object, with the visibility of the at least one part of the virtual object defined according to a fraction of the at least one part of the virtual object which is visible or invisible in the view.

For example, the virtual object or a part of the virtual object is considered to be invisible when the virtual object or the part of the virtual object locates behind at least a part of the real object with respect to the viewer or when the virtual object or the part of the virtual object is out of a field of a view of the viewer.

According to an embodiment, the step of determining the at least one movement is performed according to the pose of the viewer, the spatial relationship between the real object and the virtual object, the models of the real object and the virtual object, and the visibility condition.

According to an embodiment, the method further comprises determining a cost of the at least one movement, wherein the at least one movement is determined according to the cost.

For example, the at least one movement includes at least one translation and/or at least one rotation, and the cost of the at least one movement is determined depending on a distance of at least one translation, and/or a direction of at least one translation, and/or an angle of at least one rotation, and/or an axis of at least one rotation, and/or a pre-defined range for moving the viewer and/or at least part of the real object, and/or the physical energy needed to perform the least one movement.

Preferably, providing the information indicative of the at least one movement comprises providing information for giving at least one instruction visually and/or acoustically and/or tangibly about at least part of the at least one movement.

According to an embodiment, the method further comprises creating a view of the virtual object by a virtual camera using a method including rasterization, ray casting or ray tracing, wherein the determining the visibility of the virtual object is further performed according to the view of the virtual camera onto the virtual object.

For instance, the model of the real object and/or the model of the virtual object is a CAD model, a polygon model, a point cloud, a volumetric dataset, or an edge model, or uses any other representation describing dimensions about at least part of the respective object. In case the real object is non-rigid, e.g. articulated or deformable, the model of the real object may further contain information on how the real object can be deformed or information about the kinematic chain of the real object.

According to an embodiment, the viewer is or comprises a projector, and the visibility of the virtual object is further determined according to a position of a projection surface onto which visual content can be projected by the projector, wherein the position of the projection surface is relative to the projector and the projection surface is at least part of the real environment.

For example, the position of the projection surface is determined based on a tracking system that tracks the projector and the projection surface, or a tracking system that tracks one of either the projector or the projection surface and has a known spatial relationship relative to the respective other one of the projector and the projection surface.

According to an embodiment, the viewer is or comprises an eye, and the visibility of the virtual object is further determined according to a position of a semi-transparent display (such as a screen or glasses) on which visual content is displayed, wherein the position of the semi-transparent display is relative to the eye or relative to the real object.

According to another aspect, the invention is also related to a computer program product comprising software code sections which are adapted to perform a method according to the invention. Particularly, the software code sections are contained on a computer readable medium which are non-transitory. The software code sections may be loaded into a memory of one or more processing devices as described herein. Any used processing devices may communicate via a communication network, e.g. via a server computer or a point to point communication, as described herein.

### DESCRIPTION OF THE DRAWINGS

Aspects and embodiments of the invention will now be described with respect to the drawings, in which:

FIGS. 1-8 show respective exemplary Augmented Reality applications where a real object located in a real environment is captured by a camera of a mobile device in accordance with embodiments of the invention,

FIG. 9 shows a projective Augmented Reality setup comprising a real object and a video projector which emits spatially modulated visible light onto the real object,

FIG. 10 illustrates an exemplary optical see-through Augmented Reality device with a semi-transparent display which allows showing virtual objects overlaid with the real environment.

FIG. 11 shows a flow diagram of an embodiment of a method according to the invention.

Note that throughout all figures, real objects are drawn with solid lines regarding their shape outlines, crucial or important (parts of) virtual objects are drawn with dashed lines and insignificant (or non-important) (parts of) virtual objects are drawn with dotted lines regarding their shape outlines.

### DETAILED DESCRIPTION

In the context of this disclosure, crucial (parts of) virtual objects shall be understood as being those (parts of) virtual objects that need to be visible for the user to understand the information communicated by the virtual object(s) or to understand shape of the virtual object(s), while insignificant (parts of) virtual objects can help understanding the information but are not important or mandatory to be visible. Any crucial (parts of a) and/or insignificant (parts of a) virtual object may be determined manually or automatically. Visible parts of virtual objects are drawn shaded for shape fill, while invisible parts are left white for shape fill.

Although various embodiments are described herein with reference to certain components, any other configuration of components, as described herein or evident to the skilled person, can also be used when implementing any of these embodiments. Any of the devices or components as described herein may be or may comprise a respective processing device (not explicitly shown), such as a microprocessor, for performing some or more of the tasks as described herein. One or more of the processing tasks may be processed by one or more of the components or their processing devices which are communicating with each other, e.g. by a respective point to point communication or via a network, e.g. via a server computer.

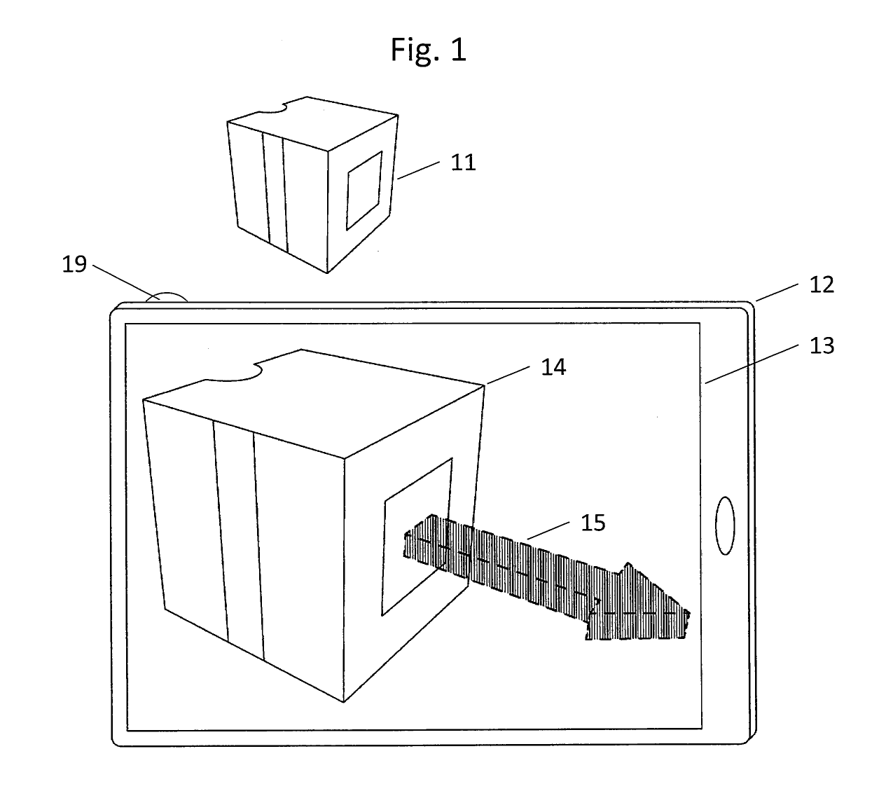

FIG. 1 shows an exemplary video see-through Augmented Reality application where a real object 11 located in a real environment is captured by the back-facing camera 19 of a mobile device 12 (such as a mobile phone or tablet computer) comprising a display 13 on which the captured camera image 14 of the real object is displayed and a virtual object 15 (spatially) related to the real object is superimposed perspectively correct based on a pose of the camera 19 relative to the real object 11 and a spatial relationship between the real object 11 and the virtual object 15. The pose of the camera could be determined based on the camera image 14 by using known vision-based pose estimation methods as disclosed below. The spatial relationship between the real object 11 and the virtual object 15 is pre-known.

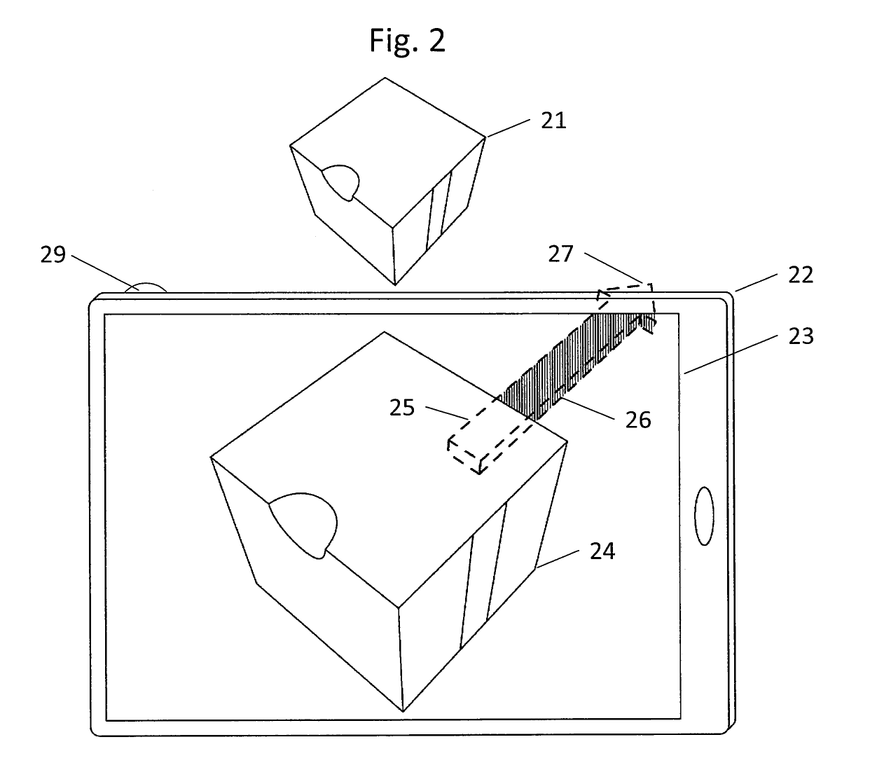

FIG. 2 shows basically the same setup as FIG. 1, but with a different position and orientation of the mobile device 22 with respect to the real object 21. The display 23 again shows the image 24 of the real object captured by the back-facing camera 29. The position and orientation of the virtual object in this case is determined from the position and orientation of the back-facing camera 29 with respect to the real object 21 and the spatial relationship between the real object 21 and the virtual object with parts 25-27. In the present situation, a part 25 of the virtual object is located behind the real object with respect to the camera 29, and therefore is occluded by the real object. This could make the part 25 of the virtual object invisible to the user due to the visualization method for not displaying the occluded part of the virtual object. Another part 26 of the virtual object is not occluded by the real object and is also inside the field of the view of the camera 29 and therefore visible to the user. A third part 27 of the virtual object is located outside the field of the view of the camera 29. Therefore, this part 27 of the virtual object is not visible to the user. Note that FIG. 2 does show these parts striped for better explanation but it wouldn't be visible to the user.

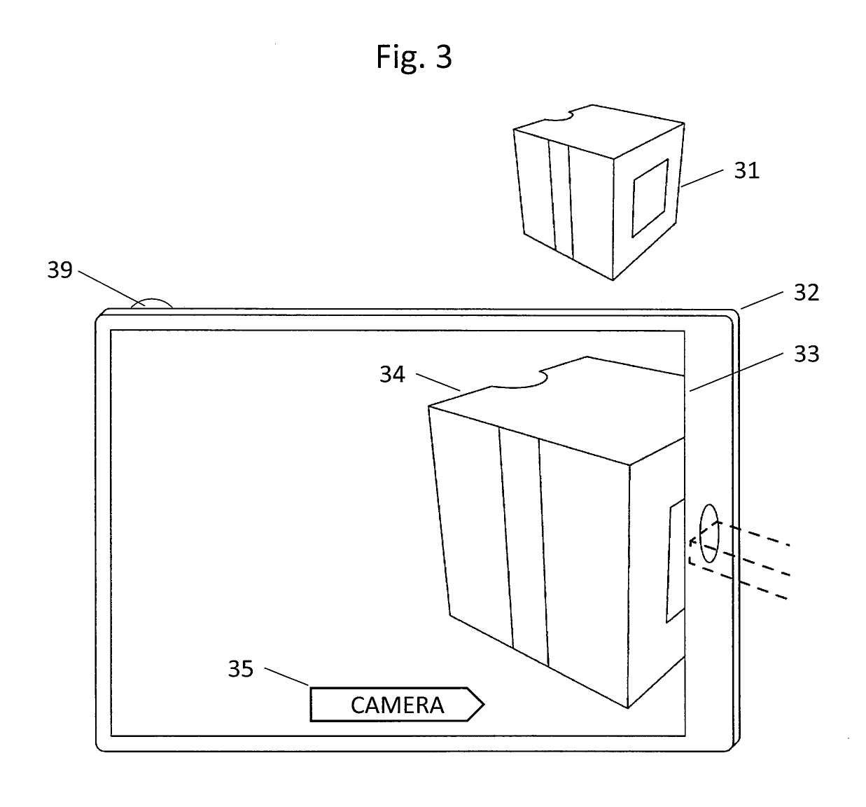

FIG. 3 shows basically the same setup as FIG. 1, but with another different position and orientation of the mobile device 32 with respect to the real object 31. The display 33 again shows the image 34 captured by the back-facing camera 39. However, as the virtual object locates outside of the field of the view of the camera 39, if the virtual object related to the real object was superimposed perspectively correct onto the image it would entirely be outside the camera image and consequently not visible to the user. Therefore, according to the present invention, there is determined a movement (in this example a camera motion, i.e. translation of the mobile device along its screen plane) that would result in the virtual object related to and registered with the real object being visible to the user again. An information related to this movement (e.g. a desired camera motion) in the present example is communicated to the user visually, e.g. by means of an indicative arrow 35 for indicating the movement such that the virtual object will become visible after performance of the movement.

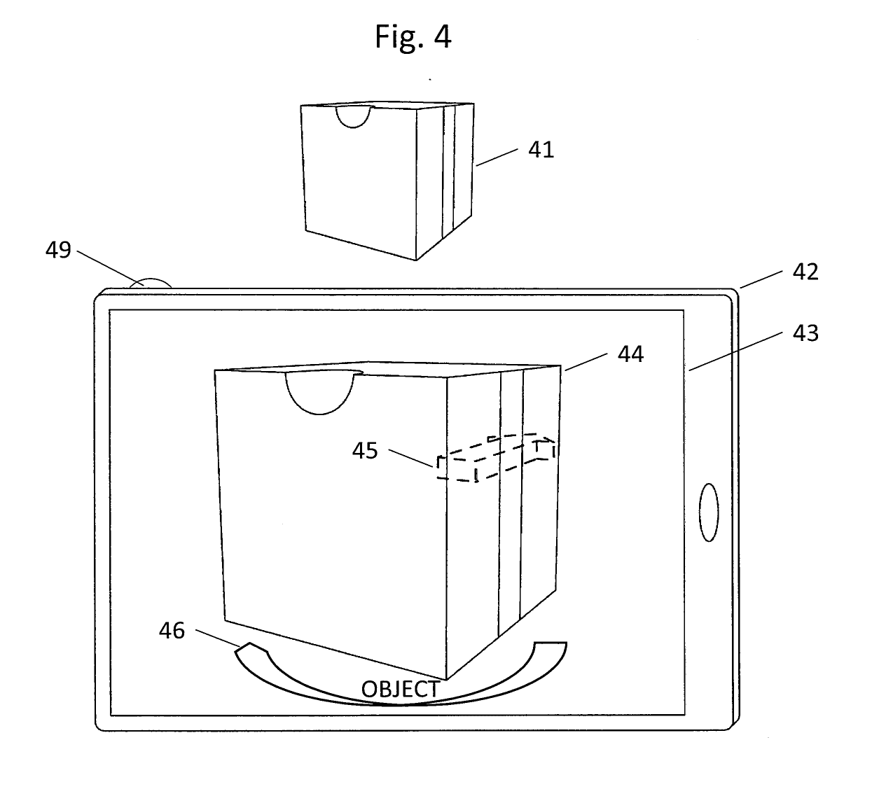

FIG. 4 shows basically the same setup as FIG. 1, but with another different position and orientation of the mobile device 42 with respect to the real object 41. The display 43 shows the camera image 44 of the real object captured by the back-facing camera 49. In the present spatial constellation of camera and real object, the virtual object 45 is related to a part of the real object which is currently not visible in the camera image 44. The (crucial) virtual object 45 is occluded by the real object with respect to the camera 49. Independent of whether the rendering handles this occlusion correctly or not, the current camera viewpoint is not suited to intuitively observe and understand the virtual object. Therefore, according to the present invention, there is determined a movement (e.g. a rotation of the real object) to be performed by the user such that the (crucial) virtual object is not (fully) occluded by the real object anymore and (at least partially) inside the camera field of view, and therefore visible to the user. The required user action is visualized, e.g. by means of an arrow 46 to help the user rotate or re-orient the real object relative to the camera that allows for observation of the virtual object.

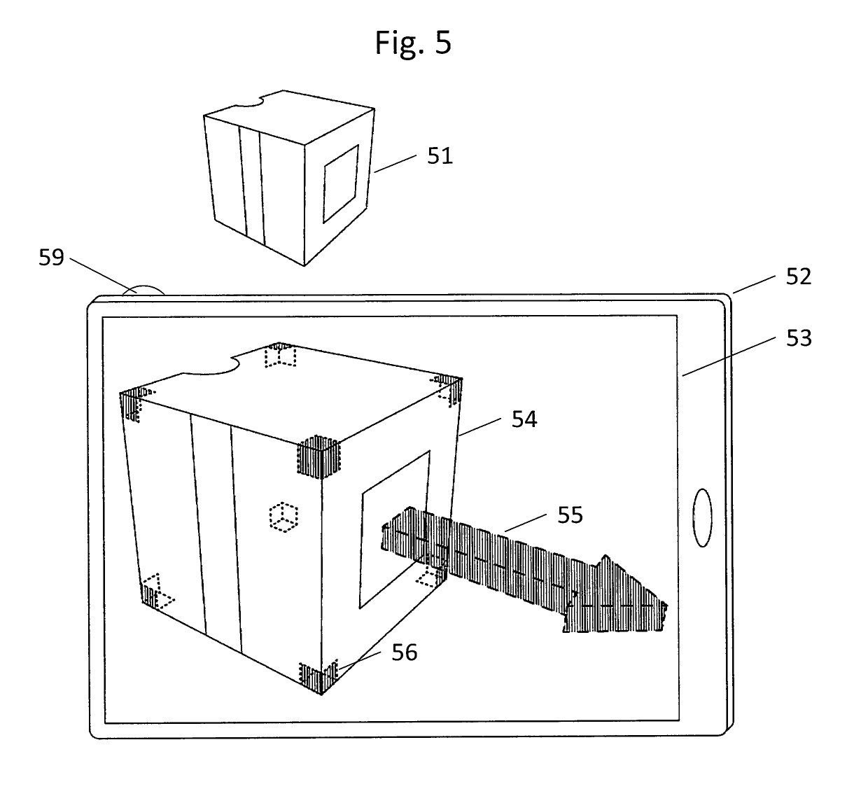

FIG. 5 shows basically the same scene as FIG. 1. The real object 51 is captured by the back-facing camera 59 of the mobile device 52 and the display 53 thereof shows the captured image 54 of the real object. This image is superimposed with a crucial virtual object 55 and some insignificant virtual objects 56 in a perspectively correct way. The portions 55 and 56 may be separate virtual objects or may form different parts of a virtual object. Thereby the assumption is that it is important for the user to see at least part of the crucial virtual object 55 in order to use the AR application in a meaningful way, while it is not required for the user to see insignificant virtual objects 56, and thus the visibility condition may be determined to be fulfilled if the portion 55 is (partially) visible. In this example, the method will not determine any movements, as the visibility condition is fulfilled.

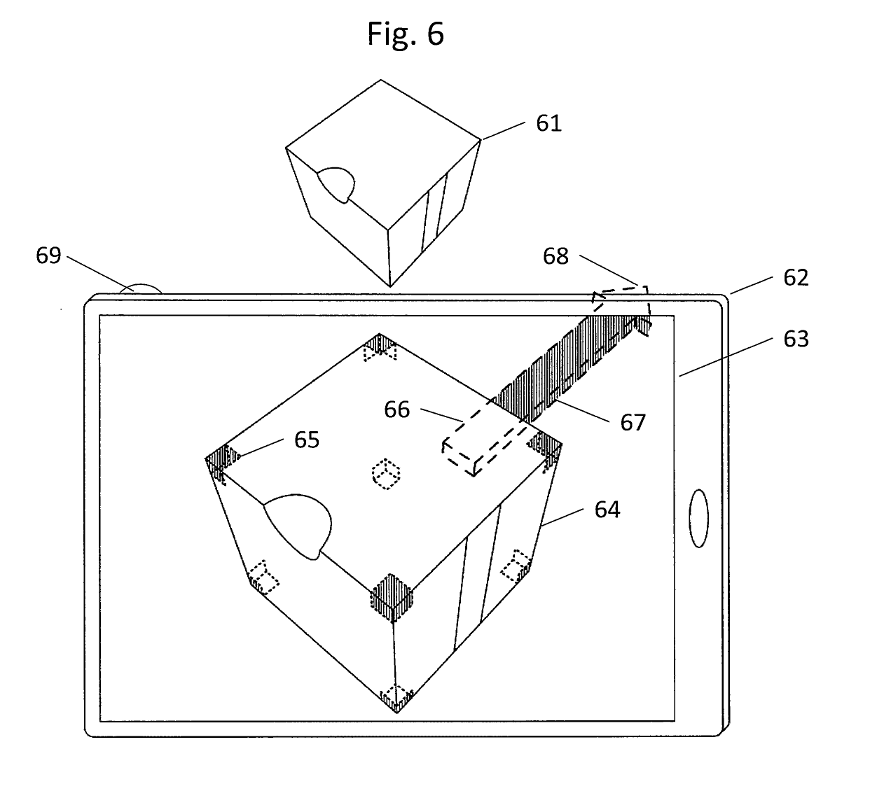

FIG. 6 shows basically the same scene as FIG. 2. The real object 61 is imaged by the back-facing camera 69 of the mobile device 62 and the display 63 shows the captured image 64 of the real object. There are insignificant virtual objects 65 being displayed perspectively correct onto the camera image. The crucial virtual object 66-68 is in this configuration partially occluded (part 66 of virtual object) by the real object, partially visible (part 67) to the user, and partially outside (part 68) the field of view of the camera 69. While parts 66 and 68 are not visible to the user, part 67 is visible providing sufficient information to the user, and thus the visibility condition may be determined to be fulfilled if the part 67 is visible. In this example, the method will not determine any movements, as the visibility condition is fulfilled. For the insignificant virtual objects 65 there is no visibility condition defined. Their visibility does not have any impact on the determination of movements.

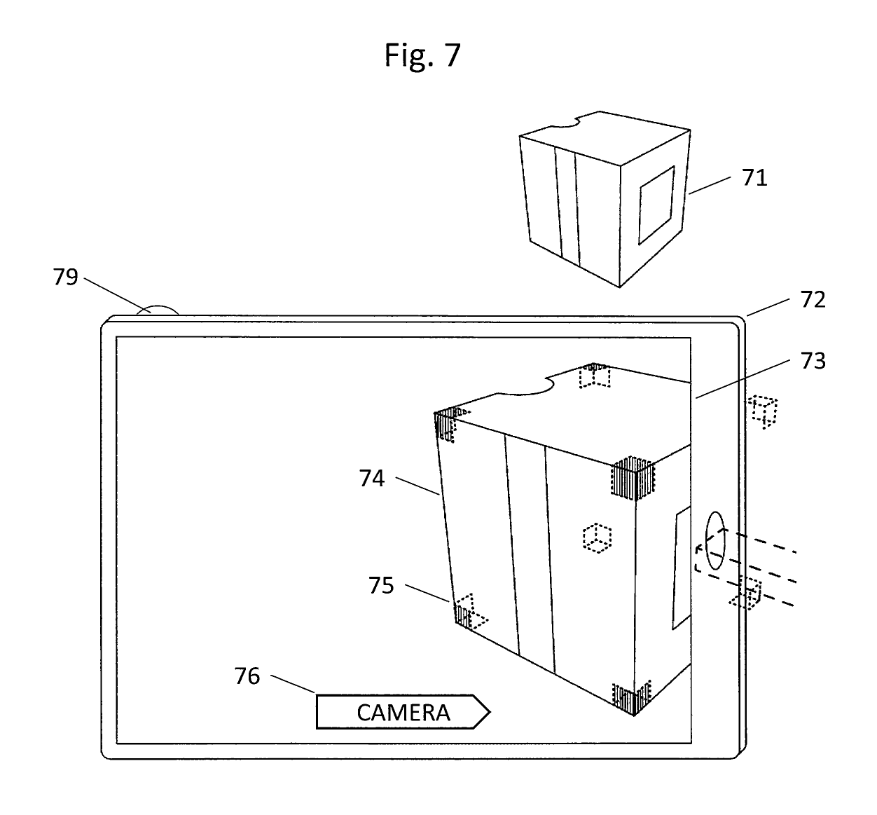

FIG. 7 shows basically the same situation as FIG. 3. The display 73 of mobile device 72 shows the camera image 74 of the real object 71 captured by the back-facing camera 79 and superimposes insignificant virtual objects 75 perspectively correct onto the camera image. The crucial virtual object is related to the real object in such a way that it is located outside of the portion of the real object that is visible in the camera image. As the crucial virtual object is not visible in the current spatial constellation between camera and real object, an embodiment of this invention computes a camera motion (here, a translation of the camera) to perform such that the crucial virtual object is at least partially visible in the camera image again after translating the camera. The required camera motion is indicated to the user with an arrow 76 in the present embodiment.

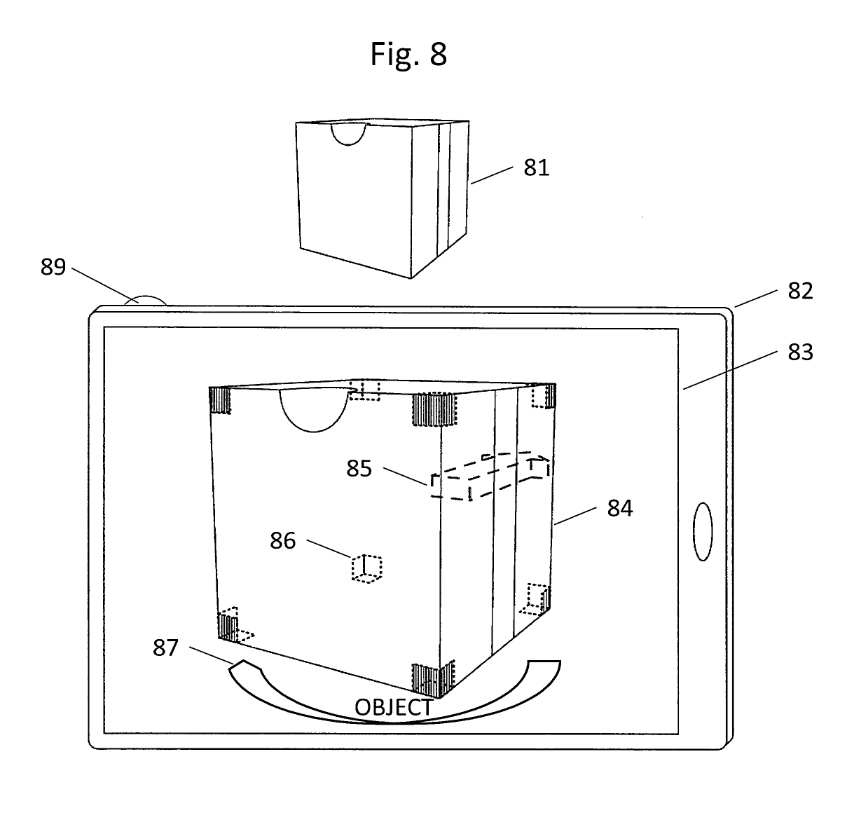

FIG. 8 shows basically the same situation as FIG. 4. The display 83 of mobile device 82 shows the image 84 of the real object 81 captured by the back-facing camera 89 and spatially registered overlays of insignificant virtual objects 86. A crucial virtual object 85 is fully occluded by the real object 81 in its image 84 from the current camera position making the information to be communicated by the application incomprehensible. Therefore, an embodiment of the present invention computes in this example a motion to be applied to the real object which results in the crucial virtual object being at least partially visible in the camera image and displays it with an arrow 87. The computed motion in this example is rotating the real object 81, which can be performed in reality, e.g., by the user rotating the real object 81.

Note, that instead of instructing the user to move the camera relative to a real object or to move the real object such that the (crucial) virtual object becomes (partially) visible to the user, the present invention can determine any movement and communicate any kind of information related to any kind of movement to be performed by the user which results in the (crucial) virtual object being (partially) visible to the user. This, for example, includes moving the head of the user for optical see-through AR setups, or moving a display.

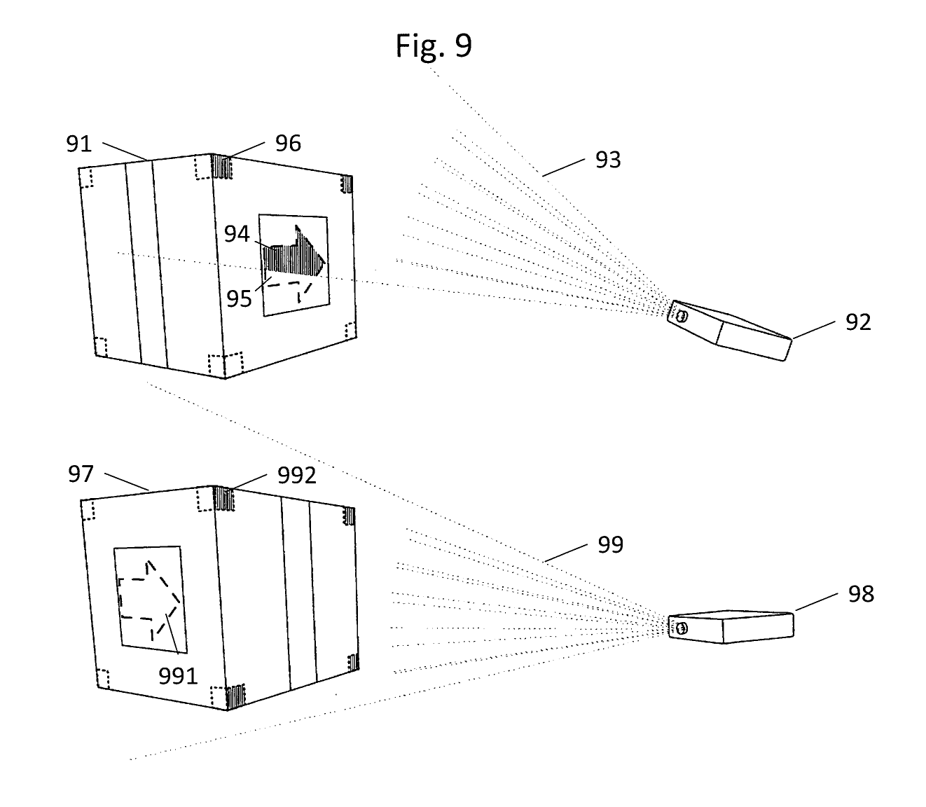

FIG. 9 shows a projective Augmented Reality setup comprising a real object 91 and a video projector 92 which emits spatially modulated visible light 93 onto the real object 91. The pose of the projector 92 with respect to the real object 91 can be determined by a variety of means, as known in the art. Knowing this pose enables the projector 92 to emit spatially modulated light 93 onto the real object 91 in such a way, that insiginifcant virtual objects 96 and crucial virtual objects 94 can be displayed on the real object 91 in a spatially registered way based on the known spatial relationship between the real object and the virtual objects. Depending on the pose of the projector 92 with respect to the real object 91 and on its field of view, (crucial) (parts of) virtual objects might be partially visible (here: part 94) if they are located within the field of view of the projector, and partially invisible (here: part 95) if they are not.

The lower part of FIG. 9 again shows a real object 97 and a projector 98 which emits spatially modulated visible light 99 onto the real object 97. In the present pose of the projector (i.e. viewer) with respect to the real object, the crucial virtual object 991 is located at a surface of the real object which is not lit by the projector because it is occluded by another surface (here: the front surface of the real object 97 facing the projector 98). This results in the crucial virtual object 991 being invisible to the viewer (projector) and consequently also to the user. In this example, the insignificant virtual object 992 is not of concern. The present invention aims at identifying such situations, determining a movement to be performed, and then communicating to the user information regarding the determined movement which shall result in the crucial virtual object 991 being visible in accordance with a defined visibility condition for that object.

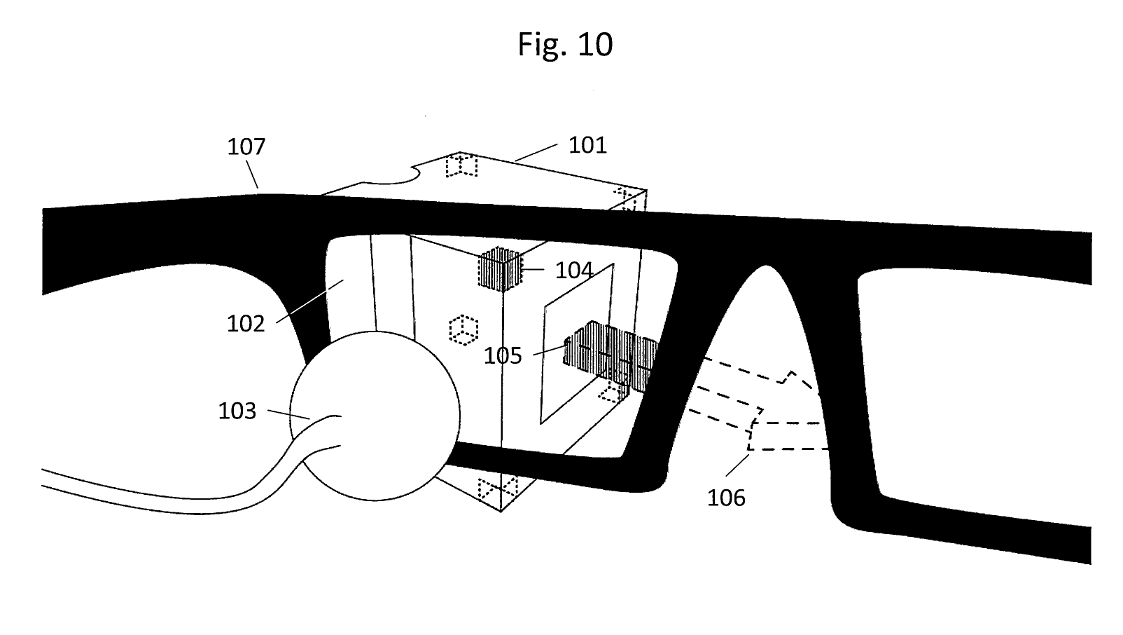

FIG. 10 illustrates an exemplary optical see-through Augmented Reality device 107 containing a semi-transparent display 102 (such as a head-worn glasses or helmet). A real object 101 can be optically seen through the display 102 by an eye 103 of the user. The display 102 further allows to show insignificant virtual objects 104 and crucial virtual objects 105 spatially registered for a viewer (e.g. the eye 103) given the spatial relationship between the virtual objects and the real objects and furthermore the pose of the display 102 and the viewer (e.g. eye 103) with respect to the real object 101. Those (parts of) (crucial) virtual objects 105 that are located at a position which can be seen through the display 102 are visible to the viewer (and therefore user). Other (parts of) (crucial) virtual objects 106 are invisible to the user, because according to their spatial relation to the real object 101, their location cannot be observed through the display 102 by the viewer (e.g. eye 103).

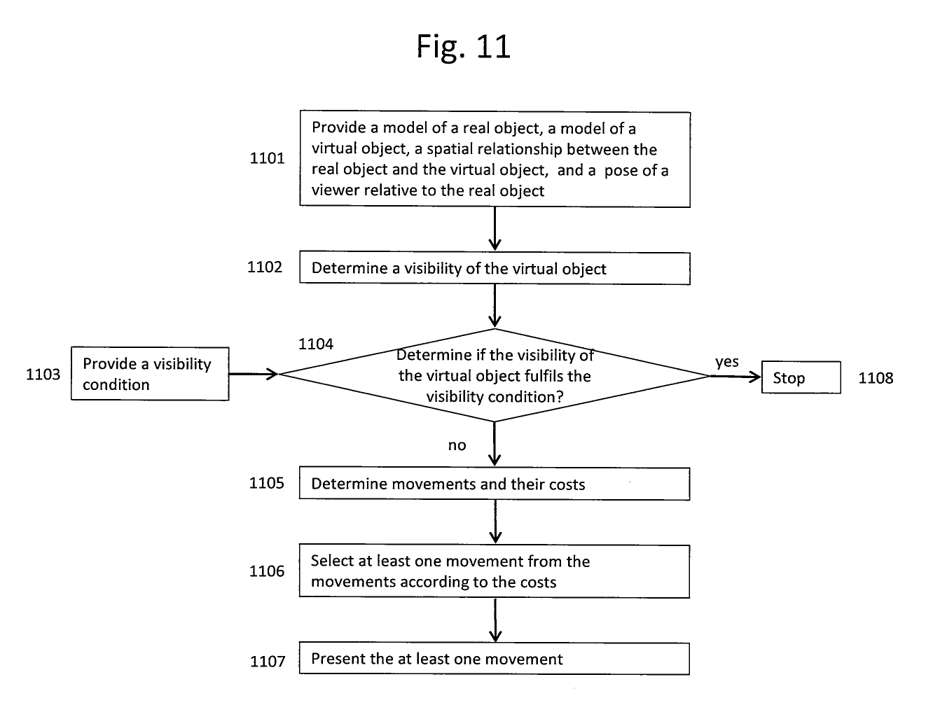

FIG. 11 shows a flow diagram of an embodiment of a method according to the invention. In step 1101, a model of a real object, a model of a virtual object, a spatial relationship between the real object and the virtual object, and a pose of a viewer relative to the real object are provided. Then, in step 1102, a visibility of the virtual object is determined, while in step 1103 a visibility condition is provided. According to step 1104, it is determined if the visibility of the virtual object fulfils the visibility condition. If yes, then the process will stop (step 1108). If not, then in step 1105 at least one movement for moving the viewer and/or the real object is determined, such that the visibility of the virtual object will fulfil the visibility condition after performance of the at least one movement. This step may also comprise determining a cost of the movement. In step 1106, at least one movement is selected from the movements according to the costs determined previously. Then, in step 1107, information indicative of the at least one movement for presentation to a user is provided. For example, the method may cause a respective device, such as a processing device, to provide corresponding signals to a display device for displaying the direction of movement on the display device visually. According to another embodiment, an information (e.g., corresponding electrical signals) may be provided to a speaker for indicating the movement to the user acoustically.

Generally, the following aspects and embodiments are described which may be applied in connection with the present invention.

Models of the Real Object(s) and the Virtual Object(s):

A model of the real object or virtual object describes the geometry of the respective object or a part of the respective object. Thereby, geometry refers to one or more attributes of the respective object including, but not limited to, shape, form, surface, symmetry, geometrical size, dimensions, and structure. The model of the real object or the virtual object could be represented by any one of a CAD model, a polygon model, a point cloud, a volumetric dataset, an edge model, or use any other representation. In case the real object is non-rigid, e.g. articulated or deformable, the model of the real object may further contain information on how the real object can be deformed or information about the kinematic chain of the real object. In any case the model of the real object is considered to be always up-to-date, i.e. consistent with the real object, even if the real object changes its shape, form, structure or geometrical size. Changes therein can be measured by a variety of means, including, but not limited to, approaches based on at least one camera image, approaches based on mechanical measurements or manual input by a user. For an articulated real object, its kinematic chain could also be used to compute positions of individual parts of the articulated real object relative to a base of the articulated real object based on current joint values. Therefore, the physical shape of the articulated real object may change, but it can be determined according to the kinematic chain and joint values.

The model may further describe the material of the object. The material of the object could be represented by textures and/or colors in the model. A model of an object may use different representations for different parts of the object.

Virtual Objects:

A virtual object can be any type of visually perceivable digital data such as a 3D object, 2D object, text, drawing, image, video, or their combination. Virtual objects can be static or animated, i.e. change their geometry and/or material and visual appearance over time. The virtual object may be generated by a computer.

Spatial Relationship:

A spatial relationship specifies how an object is located in 2D or 3D space in relation to another object in terms of translation, and/or rotation, and/or scale. The spatial relationship may be a rigid transformation or could also be a similarity transformation. A spatial relationship relates to the origins of the two objects. The origin of non-rigid objects remains the same independent of their transformation.

Viewer:

The viewer may be a camera that can capture a real object in an image. In this case, the overlay of the virtual object and the real object can be seen by the user in a video see-though AR setup or device having the camera and a display device. The viewer may also be an eye of the user. In this case, the overlaid virtual object and the real object can be seen by the user in a well-known optical see-through AR setup or device having a semi-transparent display (e.g. screen). The user then sees through the semi-transparent display the real object augmented with the virtual object blended in in the display. The viewer could also be a projector that can project visual information within its projecting area onto a projecting surface. The field of the view of the projector may depend on the field of its projecting area. In this case, a projector projects the virtual object onto the surface of the real object, a part of the real object, or (part of) the real environment. This is also known as projective AR.

Pose of the Viewer and Pose Determination:

A pose of the viewer relative to an object describes a transformation including a translation and/or a rotation between the viewer and the object. This transformation defines a spatial relationship between the viewer and the object. The viewer may view at least part of the real environment, which describes that the at least part of the real environment is located within the field of the view of the real environment. The pose of the viewer relative to the real object while the viewer views at least part of the real environment could be determined based on an image of at least part of the real environment captured by a real camera. While video see-through AR requires such camera (i.e. the viewer is the camera), it is also possible to add a real camera to an optical see-through AR or a projective AR setup or device. In these cases, the spatial relationship between this camera and the viewer (the eye or projector) can be assumed to be static and determined offline. As a consequence, estimating the pose of the real camera then can be used to estimate the pose of the viewer with respect to the real object.

For determining the pose of the camera based on an image of at least part of the environment captured by the camera, the model of the real object can be used for model based matching. The model based matching could, for example, be based on point features, edge features, or image patches of any size and form. While point features are frequently used for highly textured objects, edge features are preferred if the real object has little texture. Model based matching requires the image used for pose determination to contain at least part of the real object described by the model. Note that the real object could, for example, also include a fiducial (visual) marker in the environment.

Determining the pose of the camera can also be realized by using a visual marker. This requires the visual marker to have a known size and to be fixed relative to the real object. In this case, the camera pose with respect to the real object could be determined according to a camera pose with respect to the visual marker, which is estimated based on an image of the camera containing the visual marker. It is not necessary for the image to contain at least part of the real object when the visual marker is used for the camera pose determination.

In case the real object is non-rigid, e.g. articulated or deformable, the determined pose of the viewer may be relative to a part of the real object. For example, the determined pose of the viewer is relative to a base of an articulated real object. The kinematic chain could be used to compute positions of individual parts of the articulated real object relative to its base. Therefore, a pose of the viewer relative to every individual parts of the articulated real object could be determined accordingly.

Various vision based pose estimation methods have been developed to estimate poses of at least part of the articulated real object with respect to a camera based on at least one camera image. For example, the poses of individual parts of the articulated real object relative to the camera could be determined according to at least one camera image and the kinematic chain. The poses of individual parts of the articulated real object relative to the camera could be determined according to at least one camera image and 3D models of the individual parts.

The proposed invention can, in principle, be applied to any camera providing images of real objects. It is not restricted to cameras providing color images in the RGB format. It can also be applied to any other color format and also to monochrome images for example to cameras providing images in grayscale format or YUV format. The camera may further provide an image with depth data. The depth data does not need to be provided in the same resolution as the (color/grayscale) image. A camera providing an image with depth data is often called RGB-D camera. An RGB-D camera system could be a time of flight (TOF) camera system or a passive stereo camera or an active stereo camera based on infrared structured light. This invention may further use a light field camera, a thermographic camera, or an infrared camera for pose determination and tracking.

Visibility:

The visibility of the virtual object may be defined as a fraction (or ratio, or percentage) between a part of the virtual object being visible or invisible and the whole virtual object. In this case, the visibility may be represented by a percentage of no more than 100%.

The visibility of the virtual object may be defined as a ratio between a part of the virtual object being visible and a part of the virtual object being invisible. In this case, the visibility may be represented by a percentage.

The visibility of the virtual object may be defined as a visibility of at least one part of the virtual object. For example, the virtual object includes one or more crucial (significant or important) parts and/or one or more non-crucial (insignificant) parts. The visibility of the virtual object may be defined as a visibility of at least one of the crucial parts. The visibility of the at least one of the crucial parts may again be defined as a ratio between a portion of the at least one of the crucial parts being visible or invisible and the whole at least one of the crucial parts, or a ratio between portions of the at least one of the crucial parts being visible and invisible, respectively. The individual parts of a virtual object can also be defined as multiple virtual objects where each virtual object has its own visibility.

Visibility Determination:

Depending on the pose of the viewer relative to the real object and the spatial relationship between the real object and the virtual object, the virtual object or a part of the virtual object can be located in front of the real object or behind the real object with respect to the viewer. Common visualization techniques would not display those parts of the virtual object that are located behind the real object. Thus, the parts of the virtual object become invisible.

The virtual object or a part of the virtual object is considered to be invisible if the virtual object or the part of the virtual object locates behind at least part of the real object with respect to the viewer or if the virtual object or the part of the virtual object is out of the field of the view of the viewer.

In the projective AR setting, each part of the virtual object can either be projected onto a physical surface (i.e. projection surface) from the pose of the viewer (i.e. projector) or it is not projected onto any physical surface and can therefore not be observed, which makes it invisible. The position of the projection surface relative to the projector could be used to determine if the part of the virtual object could be projected onto the projection surface or not. If the projection surface locates within the projection area of the projector, visual content (e.g. at least a part of the virtual object) may be able to be projected on the surface. The projection surface may be a part of the real object or an independent real physical surface not contained in the real object. Further, a preferred projection surface may be occluded by another real object with respect to the projector, for example the another real object is located between the preferred projection surface and the projector.

In the optical see-through AR setup, the virtual object is displayed on the semi-transparent display and the user's eye could see the virtual object superimposed while observing the real environment through the display.

The semi-transparent display may be out of line of sight between the eye and the virtual object. The line of sight may be determined according to a spatial relationship between the virtual object and the viewer (i.e. the eye in this case), which can be derived from the pose of the viewer relative to the real object and the spatial relationship between the virtual object and the real object. When the semi-transparent display is out of the line of sight, the virtual object cannot be displayed at a proper position. The position of the semi-transparent display relative to the eye may be estimated in order to determine if the display is out of the line of sight between the eye and the virtual object.

Virtual Camera for Visibility Determination:

A virtual camera can be defined by a set of parameters and can create views of virtual objects or scenes. A crucial parameter of a virtual camera is its pose, i.e. 3D translation and 3D orientation with respect to the virtual object or scene. This pose describes a rigid body transformation and is often parameterized by a 4×4 matrix which transforms 3D points of the virtual object given in homogeneous coordinates into the 3D coordinate system of the virtual camera via matrix multiplication. The pose of a virtual camera is also referred to as the camera's extrinsic parameters. Virtual cameras usually use the pinhole camera model and in this case the camera's intrinsic parameters include the focal length and the principal point. Common implementations of virtual cameras use the OpenGL rasterization pipeline, ray casting or ray tracing. In any case, virtual cameras create views (i.e. two-dimensional images) of (potentially 3D) virtual objects by approximations of the capturing process happening when a real camera captures a real object. In Augmented Reality, the intrinsic and extrinsic parameters of a camera are usually chosen to be consistent either with a real camera or such that they correspond to a setup of an Augmented Reality system.

Visibility of a 3D point of the virtual object can, for example, be tested by transforming it to clip coordinates, which is a part of the graphics pipeline. This process is referred to as culling of invisible points or objects. Whether the (3D) point is occluded by the real object, or not, can be determined for example via ray casting. If the intersection of a ray from the camera origin to that point with the model of the real object is closer to the camera origin than the point, then the point is occluded, i.e. not visible. Another common approach to determine visibility of 3D points of the virtual object is based on a depth buffer test. First, the model of the real object is rendered with the virtual camera using a depth buffer which stores for each pixel the distance to the closest point (fragment) of the (model of the) real object. Then the virtual object is rendered with the same virtual camera. For each point, it can be determined if it is visible or not by comparing its distance to the closest distance to a point of the real object projecting into that pixel. If the distance to the point is greater than the distance stored in the depth buffer, then the point is occluded, i.e. invisible. There are a variety of methods to speed-up visibility tests, including the use of bounding volumes and spatial data structures which could be used in the present invention.

In this regard, FIG. 2 illustrates the visibility of a virtual object. In the present configuration, a part of the virtual object 25 is occluded by the real object 24 in the image and therefore invisible, whereas another part 26 of the virtual object is visible. Yet another part 27 of the virtual object is invisible to the user because it is outside the view frustum of the virtual camera used to create the virtual view of the virtual object such that it is spatially registered with the real object.

Visibility Condition:

A visibility condition can, for example, require that at least part of the virtual object is visible in a view in order to fulfil the visibility condition. Another visibility condition could be that the virtual object is required to be fully visible, i.e. is neither (partially) occluded nor (partially) outside the viewing frustum. Another example for a visibility condition could be that at least 50% of the virtual object should be visible in the view. The condition could also be that at least 90% of the virtual object is inside the view frustum of the virtual camera (i.e. not culled) and at least 30% of the virtual object is not occluded by the real object. Thereby ratios of virtual objects might refer to the number of pixels they occupy in a given view or the number of vertices which are visible or invisible, or the number of front-facing surfaces which are visible or invisible, or any other reasonable metric.

In another example, the visibility condition may require a specific part of the virtual object to be visible in order to fulfil the visibility condition. The specific part may be a crucial (or significant or important) part of the virtual object that contains useful or important information. The specific part of the virtual object may also be defined as a separate virtual object.

Movement Determination:

The movement to be performed (for example, by the user) such that the visibility condition will be fulfilled after performance of the movement can in principle be anything including, but not limited to, moving at least part of the real object, moving a display (e.g. semi-transparent screen), moving the camera, moving the projector, moving the projection surface, and/or moving an eye (or head). The movement might also include the motion of multiple entities. An entity is one of at least part of the real object, the display, the camera, the projector, the projection surface, and the eye (head). For a given scenario, there might be several possible movements which could or should be performed by the user such that the visibility condition will be fulfilled after performance of one or more of the movements. The method might, for example, choose the movement such that it takes as little cost as possible. Thereby different kinds of motion to be applied to different entities might have different costs assigned. It should be noted that the visibility of a virtual object for a given view can be determined without the need to physically arrange hardware, e.g. at least part of the real object and the viewer, to this view. The movement may only be a translation direction or a rotation axis. The rotation axis is an axis around which an object is rotated.

The cost of a movement can be based on the length of a path which an involved entity needs to be moved. It can further be based on the angle of a rotation that shall be applied to an involved entity. It may further depend on which entity needs to be moved, particularly its dimensions, weight (if known), and type, i.e. camera, display, head, real object, etc. In case the real object is non-rigid, e.g. articulated or deformable, the cost of a movement may also be based on elasticity property of the real object or based on a kinematic chain of the real object (e.g. ranges of joint movements of the articulated real object).

An involved entity to be moved may have a restricted range for the movement. The restricted range for the movement may be pre-known. For example, the user cannot jump too high or even would not jump, and thus the eye (or head) cannot be translated along gravity direction away from the ground. Such restricted movement range may be considered as the cost. For example, set maximum costs to unreachable positions.

The method may determine a movement which results in the visibility condition being fulfilled after performance. It may also determine a movement which results in a setup for which the cost of changing the setup such that the visibility condition is fulfilled is less than it is starting from the current setup.

Presenting Information Regarding the Movement to the User:

The movement (e.g. any direction thereof, or kind of movement) to be performed automatically (e.g. by machines) or manually by the user can be visually presented to the user. For example, an instruction about the movement can be displayed on a display device. The instruction may also be overlaid with a view of the real environment. The instruction could be presented as text and/or numbers about the movement, e.g. movement of the head. The instruction could also be presented visually, as a figure, e.g. using arrows and/or icons as shown in FIGS. 3 and 4. The instruction may also be presented non-visually, e.g. acoustically as spoken instructions.

Basically, the method may output appropriate information (e.g. contained in control or data signals) to an entity which presents the instruction to the user based on the received information.

The instruction about the movement could also be visually presented by displaying an occluded (invisible) part of the virtual object in a way different from when it is visible. For example, when it is visible, it is displayed with solid line, while it is displayed with dash line when it is invisible. Having this information, the user himself may figure out how to move relevant entities.

The instruction could also be presented tangibly. For example, a vibrate-able device vibrates on the left if the movement should go to the left and it vibrates on the right side of the device if the motion goes to the right. The information about the motion can include information on which entity to move, e.g. the viewer or the real object. The vibrate-able device may be attached to an optical see-though device, or a video see-through device, or a projective AR device. The vibrate-able device may also be an independent and separate device.

A combination of the previous examples could also be used to inform the user about the movement to perform.

System Setups:

There are potential different setups or devices to integrate virtual objects into the user's view onto a real object. One example is to place an optical see-though device (see FIG. 10) between the user's eye and the real object. The real object can then be directly observed through this semi-transparent display of the optical see-though device, while a view of the virtual object is computer-generated and shown on the semi-transparent display. This configuration is referred to as optical see-through AR. In this case, the eye of the user will be a viewer.

The visual integration of a virtual object and a real object (or environment) can also be performed using a video see-though device (see FIG. 1-8) which is composed of a camera and a reflective or emissive display device, e.g. LCD, LED, OLED, or E Ink. In this configuration the camera captures the real object and then displays an image of the real object overlaid with a spatially registered computer-generated view of the virtual object on the display device. This configuration is referred to as video see-through AR. In this case, the camera will be a viewer.

Another approach is to use a visual light projector (see FIG. 9) to project a (computer-generated) view of the virtual object spatially registered onto the real object. The user then directly observes the real object and the projected virtual object without the need to look at or through any physical display. In this case of projective AR, the projector is a viewer.

In projective AR, virtual objects which are placed at or close to projection surfaces (e.g. surfaces of the real object or real environment) in 3D space will appear correctly registered with the real object to the observation of the user, no matter where the user's eyes are. For virtual objects which are (partially) located further away from projection surfaces, the (computer-generated) view of the virtual object depends on the position of the user's eye(s). Therefore, approaches exist that extend the setup described above with a system to localize and track the position of the user's eye(s). This configuration (with or without eye tracking) is referred to as projective AR. The literature also uses the term spatial AR interchangeably.

All configurations described above can be extended to support more than one viewer at a time. For example both eyes of the user can be provided with separate views which can offer improved depth perception and is referred to as stereoscopy. It is also possible to provide separate views for multiple users at the same time. For simplicity we assume a monocular/monoscopic setup, i.e. one viewer at a time, in the following without limiting the scope of the invention to such setups.

In case the real object is non-rigid, e.g. articulated or deformable, the model of the real object is considered to always up-to-date, i.e. consistent with the real object, even if the real object changes its shape, form, structure or geometrical size. Changes therein can be measured by a variety of means, including, but not limited to, approaches based on at least one camera image, approaches based on mechanical measurements or manual input by a user.

Examples for Each of the Three AR Setups:

The present invention can, for example, be employed for an optical see-through Augmented Reality setup comprising a semi-transparent head-mounted display (HMD) with attached markers which enable determining the pose of the display with an infrared-based optical outside-in tracking. In this case the real object could, for example, be a printer and the virtual object could be an arrow pointing to the factory-reset button at the rear side of the printer. A user views the printer through the semi-transparent head-mounted display. The tracking system emits infrared light which is reflected by the marker attached to the head-mounted display and then imaged with the at least one infrared camera which enables determining the spatial transformation between the display and the tracking system. As the spatial relationship of the tracking system to the printer is known, the position and orientation of the display with respect to the real object, i.e. the printer, can be determined. This is then used together with a model of the printer and a model of the arrow (virtual object) to determine visibility of the virtual object in this configuration. As the factory-reset button is located at the rear side of the printer and the user is facing the printer from the front in the first view, the method determines that 80% of the arrow is occluded by the printer. The visibility condition in this case requires at least 50% of the virtual object to be visible. Therefore, an appropriate action to be taken must be determined. The printer is approximately at the height of the head of the user while standing. One option to achieve a view in which the visibility condition is fulfilled would be to move the eye (therefore the head together with the worn HIVID) up so the user can watch over the printer and see the arrow from above. According to an embodiment of the present invention, this motion is assigned with a very high weight (e.g. a maximum cost) as it would require the user to either jump or to find an object to climb onto so he or she could reach the recommended head position. Therefore the method determines a different movement such as to rotate the printer about the gravity axis for a certain angle and informs the user about this. The user finally performs this action, i.e. rotates the printer such that the visibility condition of the virtual object is fulfilled.

In another embodiment, the present invention is used in a video see-through setup or device, for example, a handheld smartphone with a back-facing camera, which performs visual tracking of the real object in order to determine the pose of the camera relative to the real object. The visual tracking may be realized by using the camera to capture images of a marker in front of a bottle both glued to a table. The real object contains the marker, the bottle, and the table. The virtual object may in this case be a label attached to the bottle. By localizing the marker in the camera image, i.e. part of the real object, the spatial relationship of the camera to the real object can be determined and the pose of a virtual camera to render the virtual object spatially registered with the image of the bottle is computed. For this pose, the visibility of the virtual object is 50% as the other 50% are occluded by the bottle, which the camera observes from the side. In this case, the method determines as an action to be performed by the user to move the camera around the bottle, i.e. part of the real object. Another option to fulfil the visibility condition would be to move the real object. However, since the real object is composed of a table, a marker and a glass bottle, the cost for moving the real object is much higher than that of moving the camera, so that the method decides for the latter action. The costs of various possible or potential movements may have to be provided to the method. For example, there is given a high cost for moving the real object of the table. The user moves the phone accordingly and obtains a view of the real object with a fully visible virtual object, i.e. label being perspectively correct overlaid.

In a video see-through setup or device, the aspect ratio of width and height or resolution may differ between a camera image captured by the camera and the display and, as a result, only part of the camera image is displayed. Then the visibility determination checks if the virtual object is visible inside that part of the camera image which is actually shown on the display instead of the entire camera image.

In another embodiment, the setup is a projective AR system comprising a visible light projector and an RGB-D camera. In this configuration, the RGB-D camera is used to determine the spatial relationship between the projector and the real object. In this example the real object is a car and the projector and the RGB-D camera are rigidly attached to a wall and cannot be moved. The crucial virtual object is a design of a handle at the driver's (left) door. The pose of the viewer, i.e. the projector, relative to the real object, i.e. the car, is initially such that the projector faces the trunk of the car. As a consequence, the crucial virtual object is not visible to the viewer. There is also an insignificant virtual object which is a model of the main edges of the car to provide a context for the visualization of the crucial virtual object. The visibility condition in this case is that the crucial virtual object, i.e. the door handle, must be fully visible. After determining the visibility and determining that the visibility condition is not met, the present invention determines a movement. Because the projector and the camera are attached to a wall and cannot be moved, the cost for their translation and rotation are set to infinity. The movement at the lowest cost determined by the method finally involves moving the car such that the projector emits light onto the driver's door of the car. In this configuration, the crucial virtual object is fully visible and the visibility condition is fulfilled.

In an embodiment of the invention, the virtual object might comprise multiple parts with different visibility conditions. E.g., there might be crucial parts of a virtual object which have to be visible and there might be insignificant parts of a virtual object for which the visibility condition is defined such that it is always fulfilled, i.e. it does not matter if they are visible or not. Instead of a single virtual object that is composed of crucial and insignificant parts, there might also be multiple virtual objects where each has a spatial relationship to the real object and a visibility condition. The individual virtual objects can—depending on their visibility condition—be considered as crucial virtual objects or insignificant virtual objects. This is basically the same situation as described above in other words.

The visibility condition might aim at a desired ratio or fraction of the virtual object to be visible to the user. It can, for example, require the ratio to be equal to one, meaning that the entire virtual object is required to be visible. It can also be required to have a ratio greater than zero, meaning at least part of the virtual object needs to be visible.

1. A method of providing information associated with a view of a real environment superimposed with a virtual object, the method comprising
obtaining a model of a real object located in a real environment and a model of a virtual object superimposed in a view of the real environment;
determining a spatial relationship between the real object and the virtual object;
determining a pose of a device displaying the view of the real environment relative to the real object;
determining a visibility of the virtual object in the view according to the pose of the device, the spatial relationship between the real object and the virtual object, and the models of the real object and the virtual object;
and
if the virtual object is not visible in the view, determining at least one movement for moving at least one of the device and at least part of the real object such that the virtual object is visible in the view in response to the at least one movement, and
providing, by the device, information indicative of the at least one movement.

2. (canceled)

3. The method according to claim 1, wherein the visibility of the virtual object is defined according to a fraction of the virtual object which is visible in the view.

4. The method according to claim 1, wherein the visibility of the virtual object is defined according to a visibility of at least a part of the virtual object.

5. (canceled)

6. The method according to claim 1, wherein the virtual object or a part of the virtual object is determined to be not visible when at least part of the virtual object is located behind at least a part of the real object with respect to the viewer or when the virtual object or the part of the virtual object is out of a field of a view of the device.

7. The method according to claim 1, wherein the at least one movement is determined according to the pose of the device, the spatial relationship between the real object and the virtual object, the models of the real object and the virtual object, and the visibility of the virtual object.

8. The method according to claim 1, further comprising calculating a cost of the at least one movement, wherein the at least one movement is determined according to the cost.

9. The method according to claim 8, wherein
the cost of the at least one movement is determined depending on at least one selected from a group consisting of a distance of at least one translation, a direction of at least one translation, an angle of at least one rotation, an axis of at least one rotation, a pre-defined range for moving the device, a pre-defined range for moving the at least part of the real object, and the physical energy needed to perform the least one movement.

10. (canceled)

11. The method according to claim 1, wherein providing information indicative of the at least one movement comprises providing information for giving at least one instruction about at least part of the at least one movement in a manner that is at least one selected from a group consisting of visual, acoustic, and tangible.

12. The method according to claim 1, further comprising:
creating a view of the virtual object by a virtual camera using one selected from a group consisting of rasterization, ray casting and ray tracing,
wherein the visibility of the virtual object is further determined according to the view of the virtual camera onto the virtual object.

13. The method according to claim 1, wherein the model of the real object is selected from a group consisting of a CAD model, a polygon model, a point cloud, a volumetric dataset, and an edge model.

14. The method according to claim 1, wherein the device comprises a projector, and the visibility of the virtual object is further determined according to a position of a projection surface onto which visual content could be projected by the projector, wherein the position of the projection surface is relative to the projector and the projection surface is at least part of the real environment.

15. The method according to claim 14, wherein the position of the projection surface is determined according to a tracking system that tracks the projector and the projection surface.

16. (canceled)

17. (canceled)

18. (canceled)

19. (canceled)

20. (canceled)

21. (canceled)

22. A non-transitory computer readable medium comprising computer readable code which, when executed by one or more processors, causes the one or more processors to:
obtain a model of a real object located in a real environment and a model of a virtual object superimposed in a view of the real environment;
determine a spatial relationship between the real object and the virtual object;
determine a pose of a device displaying the view of the real environment relative to the real object;
determine a visibility of the virtual object in the view according to the pose of the device, the spatial relationship between the real object and the virtual object, and the models of the real object and the virtual object;
if the virtual object is not visible in the view, determine at least one movement for moving at least one of the device and at least part of the real object such that the virtual object is visible in the view in response to the at least one movement, and
provide, by the device, information indicative of the at least one movement.

23. The non-transitory computer readable medium of claim 22, wherein the visibility of the virtual object is defined according to a visibility of at least a part of the virtual object.

24. The non-transitory computer readable medium of claim 22, wherein the at least one movement is determined according to the pose of the device, the spatial relationship between the real object and the virtual object, the models of the real object and the virtual object, and the visibility of the virtual object.

25. The non-transitory computer readable medium of claim 22, wherein the virtual object or a part of the virtual object is determined to be not visible at least part of the virtual object is located behind at least a part of the real object with respect to the viewer or when the virtual object or the part of the virtual object is out of a field of a view of the device.

26. A system for providing information associated with a view of a real environment superimposed with a virtual object, comprising:
a camera;
a display;
one or more processors; and
a memory coupled to the one or more processors and comprising computer code which, when executed by the one or more processors, causes the one or more processors to:
obtain a model of a real object located in a real environment and a model of a virtual object superimposed in a view of the real environment;
determine a spatial relationship between the real object and the virtual object;
determine a pose of the system relative to the real object;
determine a visibility of the virtual object in the display according to the pose, the spatial relationship between the real object and the virtual object, and the models of the real object and the virtual object;
if the virtual object is not visible in the display, determine at least one movement for moving at least one of the system and at least part of the real object such that the virtual object is visible in the display in response to the at least one movement, and
provide information indicative of the at least one movement.

27. The system of claim 26, wherein the visibility of the virtual object is defined according to a visibility of at least a part of the virtual object.

28. The system of claim 26, wherein the at least one movement is determined according to the pose of the system, the spatial relationship between the real object and the virtual object, the models of the real object and the virtual object, and the visibility of the virtual object.

29. The system of claim 26, wherein the virtual object or a part of the virtual object is determined to be not visible at least part of the virtual object is located behind at least a part of the real object with respect to the viewer or when the virtual object or the part of the virtual object is out of a field of view of the display.
